(19) United States
(12) Patent Application Publication
(10) Pub. No.: US 2026/0285666 A1
(43) Pub. Date: Sep. 24, 2026

(54) LIQUID FILLING AND DISCHARGE APPARATUS FOR BARREL AND BARREL-SHAPED BODY CONVEYING APPARATUS

(71) Applicant: Taizo NISHIMOTO, Kashiba-shi (JP)

(72) Inventor: Taizo NISHIMOTO, Kashiba-shi (JP)

(21) Appl. No.: 19/570,299

(22) Filed: Mar. 18, 2026

(30) Foreign Application Priority Data
Mar. 18, 2025 (JP) 2025-044053

(51) Int. Cl. B67C 3/30; B67C 3/00

(52) U.S. Cl. CPC B67C 3/30; B67C 3/007

(57) ABSTRACT

A liquid filling and discharge apparatus for a barrel is used for filling a liquid into an interior of the barrel or discharging a liquid from the interior of the barrel. The liquid filling and discharge apparatus includes a sensor, a long tubular nozzle, and a drive mechanism. The sensor is configured to detect a position of an injection and discharge opening provided on a side surface of the barrel. The long tubular nozzle is configured to be inserted into the injection and discharge opening to inject and discharge the liquid. The drive mechanism is configured to move the nozzle up and down.

### CROSS-REFERENCE TO RELATED APPLICATION

This application claims priority from Japanese Patent Application No. 2025-044053 filed with the Japan Patent Office on Mar. 18, 2025, the entire content of which is hereby incorporated by reference.

### BACKGROUND

### 1. Technical Field

The present invention relates to a barrel-shaped body conveying apparatus for conveying a barrel (a barrel-shaped body) in which alcoholic beverages are stored during production of alcoholic beverages such as whiskey and wine, and to a liquid filling and discharge apparatus for barrels for automatically injecting liquid contents (a liquid such as an alcoholic beverage) into the inside of the barrel and discharging the liquid contents from the inside of the barrel in such a barrel-shaped body conveying apparatus.

### 2. Related Art

Barrels (columnar containers having, in a height direction thereof, middle portions bulged outward) made of wood are widely used as storage containers for alcoholic beverages such as whiskey, wine, and beer and the like. Further, in such a barrel, a bunghole (so-called dowel hole) is bored at the maximum bulged portion at the center in the height direction, and, in the manufacture of alcoholic beverage, it is necessary, via the bunghole, to inject (fill) alcoholic beverage (new liquor) into the interior of the barrel and/or to discharge (withdraw) alcoholic beverage (aged liquor) from the barrel.

As a system for filling alcohol into the interior of the barrel and discharging alcohol from the barrel, as in JP-A-2003-34408, a system is known in which a barrel (an alcoholic beverage barrel) is placed on a cart provided with a stand in a state laid horizontally, the cart is conveyed to a worktable, after which an operator inserts a filling nozzle provided on the worktable in a manner hanging downward into the interior of the barrel and fills alcoholic beverage into the interior of the barrel through the filling nozzle, and an operator inserts an extraction nozzle provided on the worktable in a manner hanging downward into the interior of the barrel and removes alcoholic beverage from the barrel through the extraction nozzle.

However, a system for filling an alcoholic beverage into a barrel and discharging the alcoholic beverage therefrom, such as that described in JP-A-2003-34408 above, cannot be said to be efficient, because an operator must insert a filling nozzle and an extraction nozzle into the interior of the barrel.

The object of the present invention is to eliminate the problems of a system for filling an alcoholic beverage into a barrel and discharging the alcoholic beverage therefrom, such as in JP-A-2003-34408 described above, and to provide an automatic filling and discharge apparatus capable of automatically and efficiently injecting a liquid (such as new liquor) into the interior of a barrel and discharging a liquid (such as aged liquor) from the interior of a barrel, and a conveying apparatus for a barrel equipped with such an automatic filling/discharge apparatus.

### SUMMARY

Of the present invention, the invention described in a first aspect is a liquid filling and discharge apparatus for a barrel (barrel-shaped objects such as whiskey barrels, wine barrels, beer barrels, and the like), used for filling a liquid into an interior of the barrel or discharging a liquid from the interior of the barrel. The liquid filling and discharge apparatus includes a sensor configured to detect a position of an injection and discharge opening provided on a side surface of the barrel, a long tubular nozzle configured to be inserted into the injection and discharge opening to inject and discharge the liquid, and a drive mechanism configured to move the nozzle up and down. The barrels in the present invention are not limited to a cylindrical barrel with a middle portion in a height direction expanding outward, but also include simply a cylindrical barrel.

In the invention according to a second aspect, which is in the invention according to the first aspect, the drive mechanism is capable of moving up and down along a vertical axis direction while maintaining a state in which the nozzle is oriented in a vertical direction.

The invention according to a third aspect is a barrel conveyor apparatus including: the liquid filling and discharge apparatus for a barrel according to the first aspect and the second aspect; a chain-conveyor type conveying line that includes a plurality of support claw members to position a horizontally laid barrel, the plurality of support claw members being provided continuously at equal intervals along a longitudinal direction; a lifting device configured to raise and lower the barrel relative to the conveying line; and position correction means configured to move the lifting device so as to eliminate a misalignment thereof when a central position between the support claw members of the conveying line and a central position of the lifting device are misaligned.

The invention according to a fourth aspect, which is in the invention according to the third aspect, is a barrel conveyor system in which the lifting device includes: a rotation mechanism configured to rotate a lifted barrel around a central axis thereof; detection means configured to detect a position of a bung of the lifted barrel; bung removal means configured to pull out of the bung detected by the detection means; and holding means configured to hold the barrel so as to restrict the barrel from lifting during pull out of the bung by the bung removal means.

A liquid filling and discharge apparatus for a barrel according to claim 1 (hereinafter simply referred to as the liquid filling and discharge apparatus) is provided with a sensor to detect the position of a filling/discharge opening provided in a side surface of the barrel, an elongated tubular nozzle to be inserted into the filling/discharge opening to inject and discharge liquid, and a drive mechanism to move the nozzle up and down, and therefore, in a short time and efficiently, the liquid filling and discharge apparatus can inject liquid (new liquor, etc.) into the interior of the barrel or discharge liquid (aged liquor, etc.) from the barrel.

A filling and discharge apparatus according to claim 2 is such that a drive mechanism, while maintaining a state in which a nozzle is oriented in the vertical direction, is capable of moving up and down along a vertical axis direction, and, because a malfunction is less likely to occur, can very efficiently perform injection of liquid into the interior of the barrel or discharge of liquid from the barrel.

According to a conveying apparatus for a barrel of claim 3 (hereinafter simply referred to as the conveying apparatus), since a barrel can be guided on a conveying line to a filling and discharge apparatus with the bunghole oriented upward, liquid injection into the interior of the barrel or liquid discharge from the interior of the barrel can be performed reliably in a very short time.

According to the conveying apparatus of claim 4, since it prevents a situation in which a barrel moves on a conveying line during bung removal and can guide the barrel to a filling and discharge apparatus with the bunghole oriented exactly vertically upward, liquid injection into the interior of the barrel or liquid discharge from the interior of the barrel can be performed more reliably in an extremely short time.

### BRIEF DESCRIPTION OF DRAWINGS

FIG. 1 is an explanatory view (plan view) illustrating the conveyance apparatus;

FIG. 2 is an explanatory view (left side view) illustrating the bung removal preparation device;

FIG. 3 is an explanatory view (left side view) illustrating the bung removing device;

FIG. 4 is an explanatory view (front view) illustrating a distal portion of bung removal means;

FIG. 5 is an explanatory view (perspective view as seen from upper left) illustrating the filling and discharge apparatus;

FIG. 6 is an explanatory view (block diagram) illustrating a control mechanism of the filling and discharge apparatus;

FIG. 7 is an enlarged explanatory view (perspective view as seen upper left) illustrating the installation part of hand body of filling and discharge apparatus;

FIG. 8 is an explanatory view (left side view) illustrating the operation details for the bung removal preparation device;

FIG. 9 is an explanatory view (left side view) illustrating the operation details for the bung removal preparation device;

FIG. 10 is an explanatory view (rear view) illustrating the operation details of the bung removal preparation device; and

FIG. 11 is an explanatory view (front view) illustrating the operation details of the bung removing device.

### DETAILED DESCRIPTION

### Configurations of Conveying Apparatus

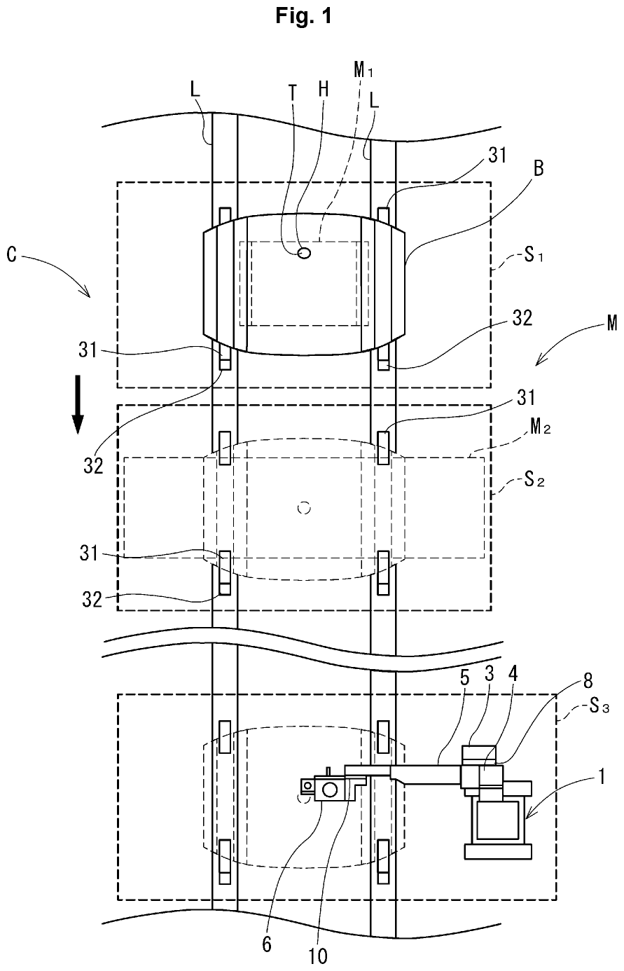

Hereinafter, a filling and discharge apparatus according to the present invention, and one embodiment of a conveying apparatus provided with the filling and discharge apparatus, will be described in detail based on the drawings. FIG. 1 illustrates an example of a conveying apparatus equipped with a filling and discharge apparatus (the conveying apparatus for barrels such as whiskey barrels). An alcoholic beverage barrel B conveyed by a conveying apparatus C is formed into a cylindrical shape in which a central portion is bulged outward by assembling wood, and in a side surface (peripheral surface) at a substantially central position in the height direction, a bunghole (so-called dowel hole) H used at the time of injection and discharge of the liquid contents is formed. And the bung (so-called dowel plug) T made of wood or plastic has been screwed into the bunghole H, and the interior of the barrel B is in a sealed state. A conveying apparatus C conveys such barrels (alcoholic beverage barrels) B, B in a state laid horizontally and, after removing a bung T at a predetermined location, conveys the barrels to a different location, where the interior thereof is filled with liquid (new liquor) (or liquid (aged liquor) is discharged therefrom).

On the upstream side of a conveying apparatus C, a bung removing device M for removing a bung T from barrels B, B laid horizontally on a chain-conveyor type conveying line L (laid horizontally such that the height direction is orthogonal to the conveying direction) is installed, and on the downstream side of the bung removing device M, a filling and discharge apparatus 1 is installed. Further, on a conveying line L, support claw members 31 to fix the horizontally laid barrels B are provided at predetermined intervals in front, rear, left, and right directions, and are arranged at equal pitch along the longitudinal direction such that four support claw members 31 are provided per barrel B. It is to be noted that, in a set of right and left support claw members 31, 31, two on each side, the upper surfaces are in a state of being inclined downward from the outside toward the inside so as to abut against the peripheral surface of the barrel B. Further, on the front surface of each support claw member 31, 31 that is installed on the downstream side (downriver) of one pair of support claw members 31, 31, a positioning member 32 is installed, respectively.

Furthermore, the area in which the bung removing device M of the conveying line L is installed is divided into a detection station S₁ to detect the position of the bung T of the barrel B and, while rotating the barrel B so that the bung T faces directly upward, performing alignment (position adjustment), and a bung removal station S₂ to remove the bung T of the barrel B after the alignment.

### Configurations of Bung Removing Device M

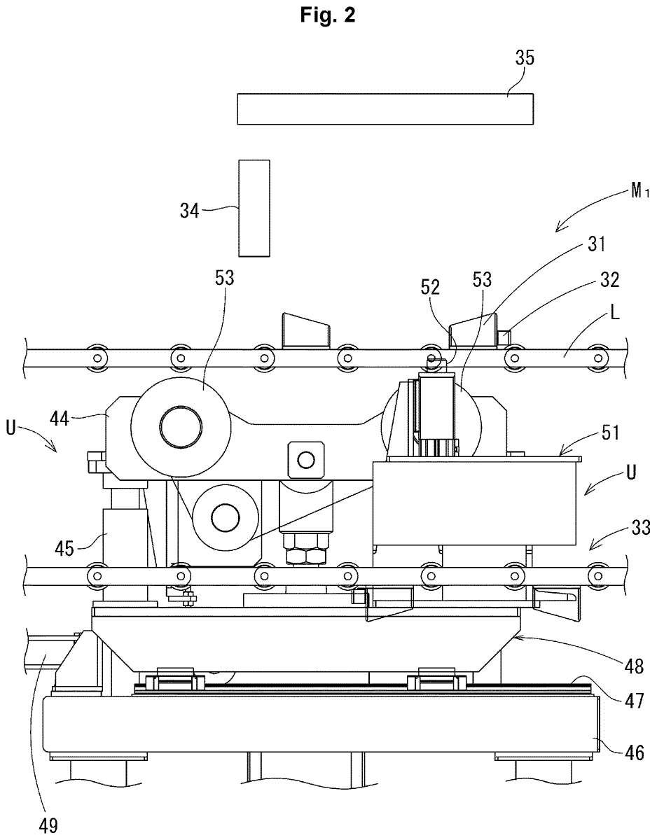

As illustrated in FIG. 1, the bung removing device M has, on the upstream side, a bung removal preparation device M₁ to fix the barrel B with the bunghole H facing straight upward and specify the position of the bung T, and a bung removing device M₂ to remove the bung T from the barrel B fixed by the bung removal preparation device M₁. FIG. 2 illustrates the bung removal preparation device M₁, and the bung removal preparation device M₁ includes a lifting and rotating device 33 which is a lifting device to lift and rotate a barrel B placed on the conveying line L, centering means 34 that, in a state in which the barrel B is lifted and rotated by the lifting and rotating device 33, detects the center in the lateral direction (the width direction of the conveying line L) of the barrel B and the center in the height direction (the height direction of the barrel B laid horizontally), a bung detection member 35 and the like to detect a bung T.

The lifting and rotating device 33 is installed so as to be located substantially directly below a barrel B conveyed on a conveying line L (a barrel B laid horizontally), and is constituted by a fixed base 46, a rail 47 provided on an upper surface of the base 46 along the longitudinal direction of the conveying line L, and a movable body 48 provided on the rail 47 so as to be movable along the longitudinal direction of the conveying line L, and the like. Further, the movable body 48 is provided with a lift portion 44 that moves up and down to lift the barrel B, a cylinder 45 that is a drive device to raise and lower the lift portion 44, and rotating bodies 53, 53, that are rotatably pivoted to the lift portion 44 in a state where they are arranged in two rows in the front-rear direction and two columns in the right-left direction, and the like. On the other hand, the bung detection member 35 uses an image-processing camera to capture an image of the center in the lateral direction of the barrel B detected by the centering means 34, and, by identifying a difference in color tone between the bung T and the body of the barrel B in that image, distinguishes between the bung T from the body of the barrel B, and detects the bung T, including specifying a position of the bung T.

Further, the lifting and rotating device 33 is equipped with a position correction unit U composed of positioning means 51 to accurately position the movable body 48 relative to a pair of front and rear support claw members 31, 31 installed on the chain-conveyor type conveying line L, and a cylinder 49 and the like to move the movable body 48 forward and backward with respect to the conveying line L. The positioning means 51 is installed outside the rotating body 53 on a front side of the lift portion 44, and a positioning projection 52 is provided at an upper end so as to be projectable and retractable in a vertical direction by an elastic member (not illustrated). On the other hand, the cylinder 49 slides the movable body 48 back and forth along the rail 47 installed on the base 46.

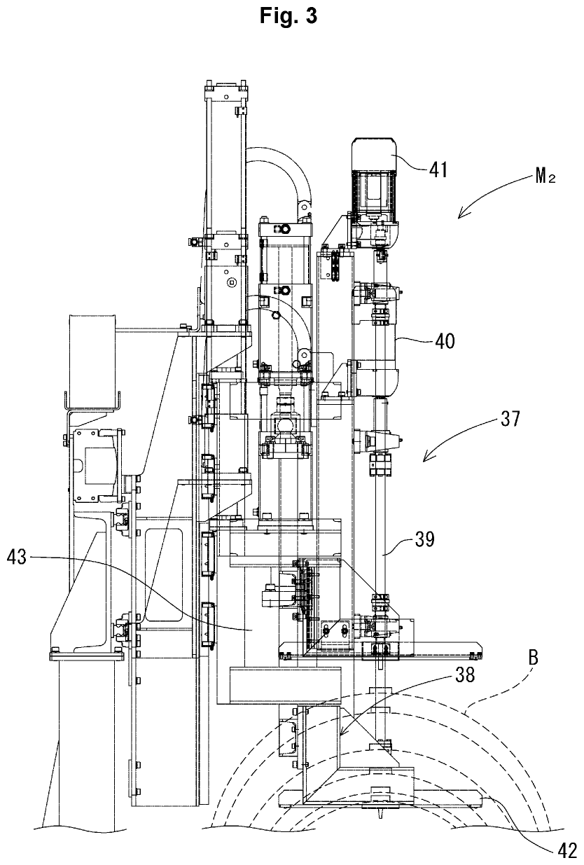

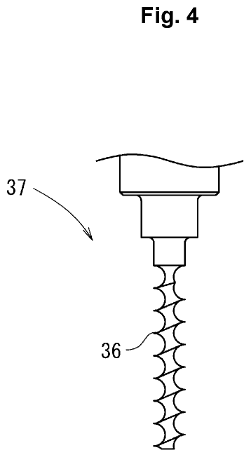

On the other hand, FIG. 3 illustrates the bung removing device M₂. The bung removing device M₂ includes bung removal means 37 including a drill 36 provided at a tip of a vertically disposed support shaft 39 to drill into the bung T, a drive device (motor) 41 to rotate the support shaft 39 around a vertical axis, a cylinder 40 to move the support shaft 39 up and down, and holding means 38 to hold the barrel B so that the barrel B is restricted from rising together with the drill 36 during removal of the bung, and the like. Further, FIG. 4 illustrates the drill 36. The drill 36 has a helical blade with the taper angle adjusted to a predetermined angle (0 to 3°). On the other hand, the holding means 38, when removing the bung, has a holding member 42 having its lower side divided into a bifurcated shape to hold the right and left sides of the bung T, and a cylinder 43 to press the holding member 42 downward.

### Configurations of Filling and Discharge Apparatus

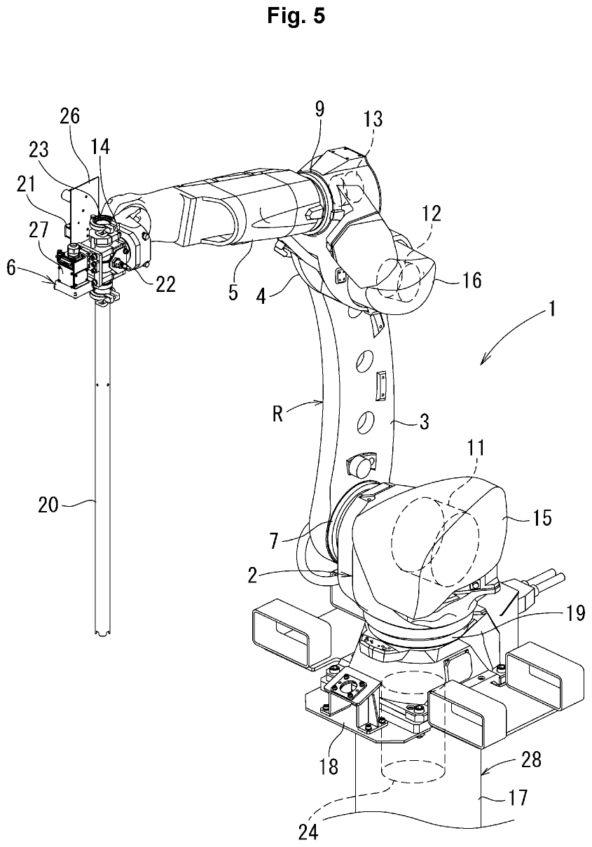

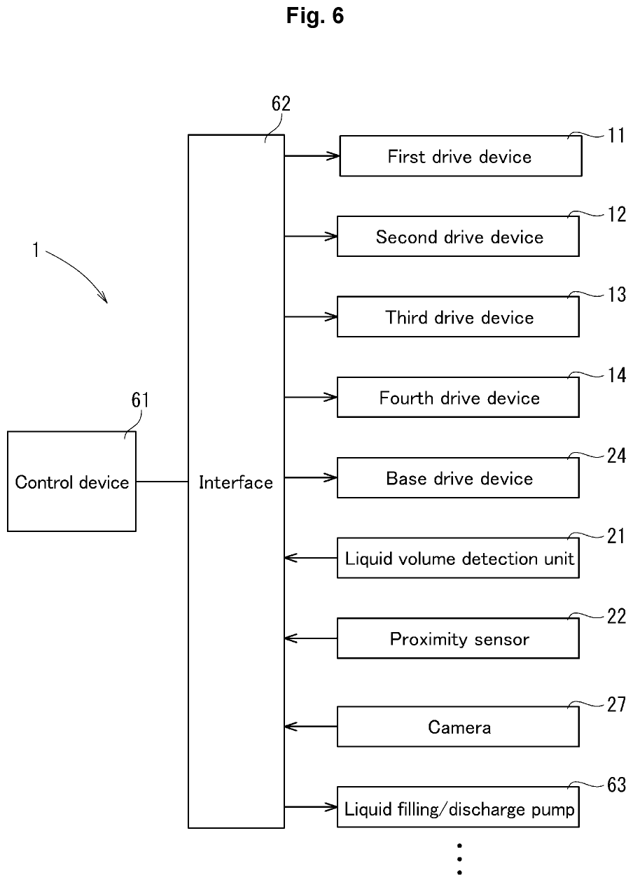

FIG. 5 illustrates the filling and discharge apparatus 1. FIG. 6 illustrates a control mechanism to operate the filling and discharge apparatus 1. The filling and discharge apparatus 1 operates a four-axis multi-joint type robot arm R based on control by a control device 61, to inject liquid (such as new liquor) from a filling liquid tank (not illustrated) into the interior of the barrel B, and to discharge liquid (such as aged liquor) from the interior of the barrel B into a recovery liquid tank (not illustrated). A robot arm R is constituted by a fixed base 28, a support body 2, a first arm 3, a second arm 4, a third arm 5, a hand body 6, a base bearing 19, a first bearing 7, a second bearing 8 (see FIG. 1), a third bearing 9, a fourth bearing 10 (see FIG. 1), a base drive device 24, a first drive device (motor) 11, a second drive device (motor) 12, a third drive device (motor) 13, a fourth drive device (motor) 14, a first housing 15, a second housing 16, and the like.

In the base 28, a mounting plate 18 is fixed on a cylindrical installation base 17. And on the mounting plate 18, the doughnut-shaped base bearing 19 is mounted, and the support body 2 having the first housing 15 incorporating the first drive device 11 is rotatably supported on the base bearing 19. Also, the doughnut-shaped first bearing 7 is mounted on the left side (upstream side) of the support body 2, and the plate-shaped first arm 3 bent in an arch shape is rotatably supported on an outside of the first bearing 7.

Furthermore, the second bearing 8 is mounted on the upper side of the first arm 3 (see FIG. 1), and the second arm 4 bent in an arch shape in a direction opposite to the first arm 3 is rotatably supported on an inner side of the second bearing 8. Further, the second housing 16 incorporating the second drive device 12 is installed at the base end of the second arm 4, and the third drive device 13 is incorporated at the distal end of the second arm 4.

Meanwhile, the doughnut-shaped third bearing 9 is mounted in front of a distal end of the second arm 4, and the substantially cylindrical third arm 5 is rotatably supported on the front side of the third bearing 9. Further, the fourth bearing 10 is mounted at a distal end of the third arm 5 (see FIG. 1), and the hand body 6 is rotatably supported via the fourth bearing 10.

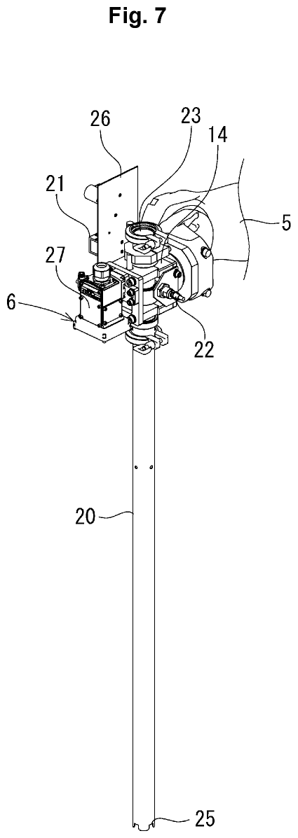

FIG. 7 is an enlarged view of the hand body 6. The hand body 6 is provided with an elongated cylindrical filling/discharge pipe (nozzle) 20 extending downward, and a flexible suction pipe (not illustrated) is connected to an upper portion of the filling/discharge pipe 20 via a suction port 23. It is noted that U-shaped notches 25, 25, are provided at equal intervals along a periphery of a distal end of the filling/discharge pipe 20. In addition, a suction pipe is connected to a filling liquid tank (not illustrated) storing, for example, new liquor, and to a recovery liquid tank (not illustrated) storing, for example, aged liquor via a liquid filling/discharge pump 63 (see FIG. 6), which will be described later.

Further, a rectangular splash guard plate 26 is provided on an outer side (upstream side) of a connection portion between the filling/discharge pipe 20 and the suction pipe so as to extend upright with a plate surface thereof along a longitudinal direction of the filling/discharge pipe 20. And, on an outer side (upstream side) of the splash guard plate 26, a liquid volume detection unit 21 is provided. The liquid volume detection unit 21 operates in interlock with a liquid level detection element (not illustrated) mounted inside the filling/discharge pipe 20 to detect an amount of liquid (new liquor, etc.) to be injected into the interior of the barrel B and stops the drive of the liquid filling/discharge pump 63 (see FIG. 6) when the barrel B becomes full. In addition, a proximity sensor 22 is provided on an outer downstream side of a connection portion between the filling/discharge pipe 20 and the suction pipe to detect a distance from a surface of the barrel B when the filling/discharge pipe 20 is inserted into the interior of the barrel B. Furthermore, a camera 27 configured to focus on a vicinity of the distal end of the filling/discharge pipe 20 is provided on the front side of the filling/discharge pipe 20. In addition, a pressure sensor (not illustrated) is provided at the base end of the filling/discharge pipe 20 to measure the pressure of a liquid such as new liquor or aged liquor, flowing downward or upward within the filling/discharge pipe 20.

In the robot arm R configured as described above, driving the base drive device 24 enables the portion above the support body 2 (that is, the support body 2, the first arm 3, the second arm 4, the third arm 5, the hand body 6, etc.) to rotate about a vertical axis with respect to the base 28. Further, driving the first drive device 11 enables the portion from the first arm 3 toward a distal end (that is, the first arm 3, the second arm 4, the third arm 5, the hand body 6, etc.) to rotate about a horizontal axis with respect to the support body 2. Further, driving the second drive device 12 enables the portion extending from the second arm 4 toward a distal end (that is, the second arm 4, the third arm 5, the hand body 6, etc.) to rotate about a horizontal axis with respect to the first arm 3. Further, driving the third drive device 13 enables the portion extending from the third arm 5 toward a distal end (that is, the third arm 5, the hand body 6, etc.) to rotate about the rotation axis of the motor serving as the third drive device 13 with respect to the second arm 4. In addition, driving the fourth drive device 14 enables the hand body 6 to rotate about a rotation axis orthogonal to a longitudinal direction of the third arm 5 with respect to the third arm 5.

Further, as illustrated in FIG. 6, the robot arm R includes the base drive device 24, the first drive device 11, the second drive device 12, the third drive device 13, the fourth drive device 14, the liquid volume detection unit 21, the proximity sensor 22, and the camera 27, which are connected to the control device 61 via an interface 62. In addition, the liquid filling/discharge pump 63 is provided. The liquid filling/discharge pump 63 is configured to inject a liquid (new liquor or the like) from the filling liquid tank (not illustrated) into the interior of the barrel B or to discharge a liquid (aged liquor) from the barrel B into the recovery liquid tank (not illustrated) and is connected to the control device 61 via the interface 62.

Then, the filling and discharge apparatus 1 actuates the base drive device 24, the first drive device 11, the second drive device 12, the third drive device 13, and the fourth drive device 14 of the robot arm R based on a command signal output from the control device 61 in response to detection signals and image information, and the like from the proximity sensor 22 and the camera 27, thereby controlling the position and orientation of the filling/discharge pipe 20 to automatically insert a distal end of the filling/discharge pipe 20 into the bunghole H of the barrel B. Furthermore, the liquid filling/discharge pump 63 is driven based on a command signal output from the control device 61 in response to a detection signal or the like from the liquid volume detection unit 21, thereby injecting liquid (new liquor or the like) into the interior of the barrel B and discharging liquid (aged liquor or the like) from the interior of the barrel B.

### Operation for Barrel Conveying Apparatus

### [Bung Removal by Bung Removing Device and Position Correction by Position Correction Unit]

In the conveying apparatus C, as illustrated in FIG. 1, the barrel B is conveyed in a horizontally laid state on a chain-conveyor type conveying line L, with a height direction thereof orthogonal to a conveying direction, while being fixed by a pair of support claw members 31, 31. Then, when the barrel B is conveyed to a detection station S₁ within an area where the bung removing device M is installed, the conveying line L is temporarily stopped to perform a preparation operation for bung removal. The horizontally laid barrel B is placed on the lifting and rotating device 33 of the bung removal preparation device M₁ (on four rotating bodies 53, 53 of the lift portion 44), and is lifted upward above the conveying line L.

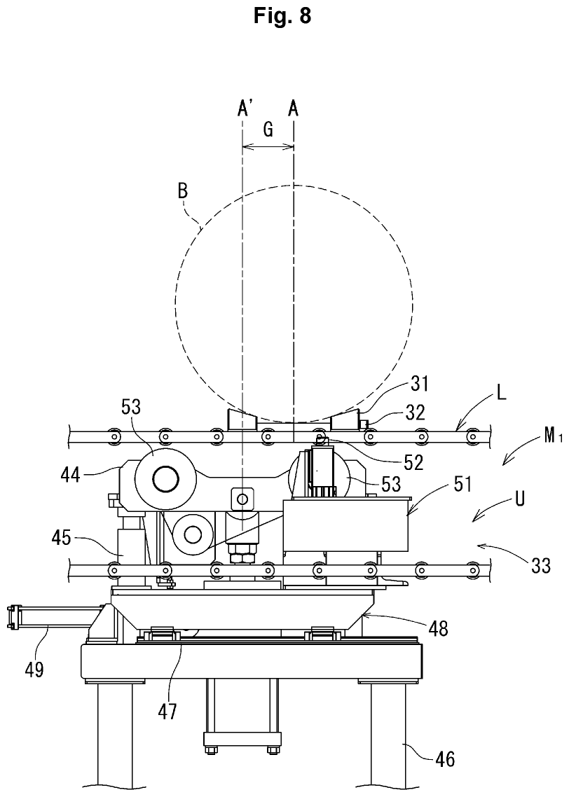

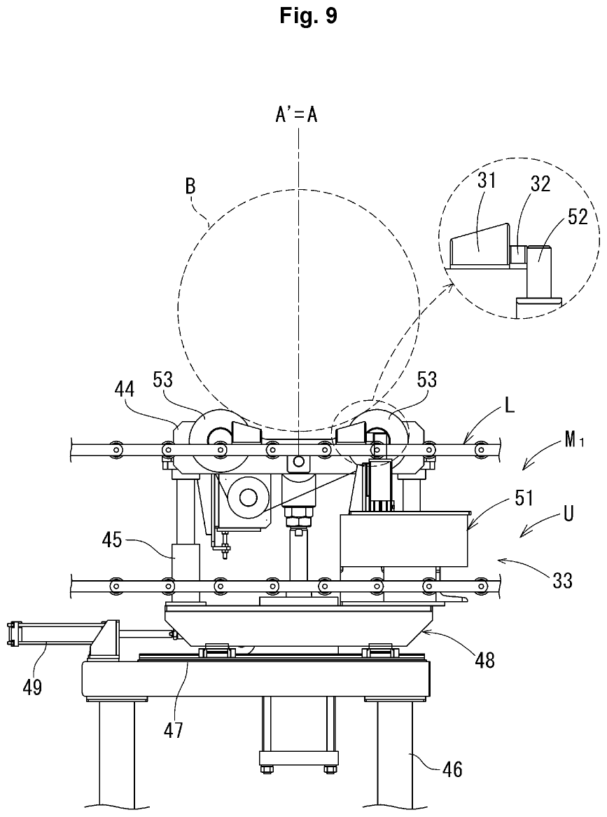

FIGS. 8 and 9 illustrate how the lifting and rotating device 33 (lift portion 44) lifts the barrel B. When the lifting and rotating device 33 lifts the barrel B, position is corrected to align a center position A of a pair of front and rear support claw members 31, 31 installed on the conveying line L with a center position A′ of rotating bodies 53, 53 of the lifting and rotating device 33, so that the barrel B can be lifted in a stable state. Such position correction is necessary because, due to elongation of a chain constituting the conveying line L (for example, elongation caused by wear of joint portions between chain segments), the center position A of the pair of front and rear support claw members 31, 31 and the center position A′ of the rotating bodies 53, 53 of the lifting and rotating device 33 become misaligned, resulting in a deviation G, as illustrated in FIG. 8.

In position correction by the position correction unit U, first, the movable body 48 is pushed forward by the cylinder 49 so that the positioning projection 52 of the positioning means 51 of the lifting and rotating device 33 is positioned downstream of the positioning member 32 provided on the downstream support claw member 31 of the pair of front and rear support claw members 31, 31. The movable body 48 slides forward along the rail 47 provided on the base 46. When the movable body 48 is pushed forward as described above, the positioning projection 52 of the positioning means 51 projects upward and abuts against the positioning member 32 provided in front of the downstream support claw member 31 as illustrated in FIG. 9.

Thus, when the positioning projection 52 protrudes and abuts against the positioning member 32, the movable body 48 is stopped as the cylinder 49 stops operating. In the lifting and rotating device 33, the configuration is such that, at a front-rear direction where the protruding positioning projection 52 abuts against the positioning member 32 of the downstream support claw member 31, the center position A′ of the rotating bodies 53, 53 coincides with the center position A of a pair of front and rear support claw members 31, 31. Accordingly, when the protruding positioning projection 52 abuts against the positioning member 32 of the downstream support claw member 31, position correction is completed.

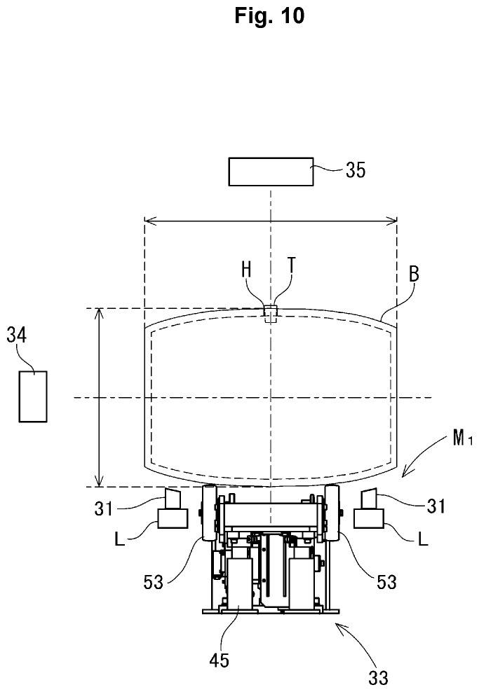

Then, as described above, when the position correction is completed, the lift portion 44 of the lifting and rotating device 33 is raised by operation of the cylinder 45 in a state where the horizontally laid barrel B is supported on four rotating bodies 53, 53 arranged at front, rear, right, and left positions (that is, the barrel B is lifted). Thereafter, as illustrated in FIG. 10, while a drive device (not illustrated) drives the rotating bodies 53, 53 to rotate the barrel B, the centering means 34 positions the barrel B at a lateral center position and a rotational center position by utilizing sensing technology and image-processing technology, thereby centering the barrel B. Then, while the centering means 34 positions the barrel B at a lateral center and a rotational center, the bung detection member 35 (a camera having an image-processing function) detects the position of the bung T, and the rotating bodies 53, 53, are driven via the control device to bring the bung T to a vertically upper position.

As described above, after positioning the bung T in a vertically upward position, the lift portion 44 is lowered by actuating the cylinder 45 of the lifting and rotating device 33, and the barrel B is placed on the conveying line L so as to be fixed by a pair of support claw members 31, 31. Since the movable body 48 of the lifting and rotating device 33 is accurately positioned with respect to a pair of support claw members 31, 31 of the conveying line L as described above, the barrel B is placed on the conveying line L while maintaining the bung T in a vertically upward position. Further, as described above, when the barrel B is placed on the conveying line L, the movable body 48 is moved backward by the cylinder 49 in preparation to detect the next barrel B to be conveyed, sliding backward along the rail 47 provided on the base 46.

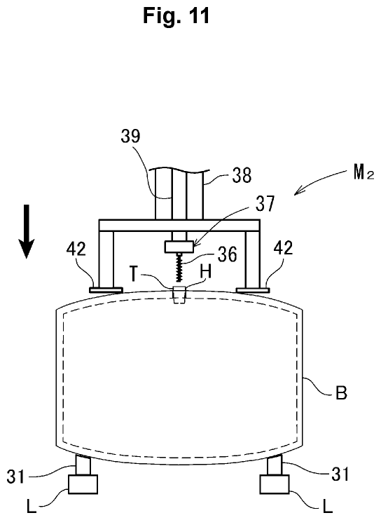

As described above, after the barrel B is placed on the conveying line L with the bung T positioned in a vertically upward position, the conveying line L is moved, as illustrated in FIG. 11, so as to convey the barrel B to the bung removal station S₂. Then, when the barrel B arrives at the bung removal station S₂, the cylinder 40 is actuated to lower the support shaft 39 of the bung removal means 37 of the bung removing device M₂ to cause the drill 36 provided at a distal end of the support shaft 39 to approach the bung T. Thereafter, the drill 36 provided at the distal end is rotated by the drive device 41 and screwed into the bung T.

Then, after the drill 36 has been sufficiently screwed into and penetrated the bung T, the cylinder 40 is actuated to raise the support shaft 39 of the bung removal means 37, thereby, pulling out the bung T. When the bung T is pulled out, if the bung T is in close contact with the barrel B, there is a possibility that the barrel B may be lifted together with the support shaft 39. To avoid such a situation, during bung removal by the bung removal means 37, the cylinder 43 is actuated to press down holding members 42, 42 of the holding means 38 to press the lateral sides (right and left) of the bung T into which the drill 36 has been screwed, thereby restricting the barrel B from being lifted. Then, as described above, after the bung has been removed, the conveying line L is driven again (moved) to convey the barrel B to a filling/discharge station S₃ to inject a liquid (new liquor) into the interior of the barrel B or discharge a liquid (aged liquor) from the barrel B.

### Injection of Liquid into Barrel and Discharge of Liquid from Barrel by Filling and Discharge Apparatus

When the barrel B reaches the filling/discharge station S₃, the filling and discharge apparatus 1 recognizes the position of the bunghole H of the barrel B by means of the camera 27. That is, the control device 61 processes an image of the outer peripheral surface of the barrel B captured by the camera 27 to identify the position of the bunghole H in X-Y coordinates on a horizontal plane. Thereafter, the conveying line L is stopped, and, based on a command from the control device 61, the base drive device 24 and the first to fourth drive devices 11 to 14 are driven to control a rotational phase of the support body 2, an inclination angle of the first arm 3, a bending angle of the second arm 4 relative to the first arm 3, a bending angle of the third arm 5 relative to the second arm 4, a rotation angle of the third arm 5 relative to the second arm 4, and a bending angle of the hand body 6 relative to the third arm 5, thereby positioning the filling/discharge pipe 20 fixed to the hand body 6 above the bunghole H of the barrel B so as to extend in a vertical direction.

Then, after it is determined, based on an image captured by the camera 27, that the tip of the filling/discharge pipe 20 is positioned above the bunghole H, the first to fourth drive devices 11 to 14 are driven again based on a command from the control device 61 to control an inclination angle of the first arm 3, a bending angle of the second arm 4 relative to the first arm 3, a bending angle of the third arm 5 relative to the second arm 4, a rotation angle of the third arm 5 relative to the second arm 4, and a bending angle of the hand body 6 relative to the third arm 5, thereby inserting the filling/discharge pipe 20 through the bunghole H into the interior of the barrel B while maintaining it in a vertical orientation. That is, the filling/discharge pipe 20 extending in a vertical direction descends while maintaining its position in the X-Y coordinates of the bunghole H in a horizontal plane.

In addition, if the tip position of the filling/discharge pipe 20 does not coincide with the position of the bunghole H, such a condition is detected by the camera 27, and, after the tip position of the filling/discharge pipe 20 is corrected, the insertion operation is repeated. Further, when the filling/discharge pipe 20 has been inserted through the bunghole H into the interior of the barrel B by a sufficient length, such a condition is detected by the proximity sensor 22 of the hand body 6, and insertion of the filling/discharge pipe 20 is stopped. Then, as described above, when the filling/discharge pipe 20 has been inserted through the bunghole H into the interior of the barrel B by a sufficient length, the liquid filling/discharge pump 63 is driven based on a command from the control device 61, thereby a filling operation of liquid (new liquor) into the interior of the barrel B and a discharge operation of liquid (aged liquor) from the barrel B are performed through a suction pipe (not illustrated).

### Effects of Filling and Discharge Apparatus and Conveying Apparatus

As described above, the filling and discharge apparatus 1 includes the sensors (the camera 27 and the proximity sensor 22) configured to detect a position of the bunghole H provided in a side surface of the barrel B, the filling/discharge pipe 20 that is a long tubular nozzle configured to be inserted into the bunghole H to fill and discharge liquid (liquor or the like), and a drive mechanism (the base drive device 24, the first to fourth drive devices 11 to 14, and the like) configured to move the filling/discharge pipe 20 in an upward and downward direction, thereby enabling efficient filling of liquid (new liquor) into the interior of the barrel B or discharge of liquid (aged liquor) from the barrel B in a short time.

Further, in the filling and discharge apparatus 1, the drive mechanism (the base drive device 24, the first to fourth drive devices 11 to 14, and the like) is configured to move the filling/discharge pipe 20 upward and downward along a vertical axis while maintaining the filling/discharge pipe 20 in the vertical orientation. Accordingly, malfunction is unlikely to occur, thereby enabling highly efficient filling of liquid into the interior of the barrel B or discharging of liquid from the barrel B.

In addition, in the filling and discharge apparatus 1, as in the above-described embodiment, the camera 27 is provided via the splash guard plate 26, on an outer side of a connection portion between the filling/discharge pipe 20 and the suction pipe (not illustrated). Accordingly, alcoholic beverage is restricted from splashing onto the camera 27 when the suction pipe is removed from the filling/discharge pipe 20 or the like, thereby enabling the camera 27 to continuously and accurately detect the position of the bunghole H.

Meanwhile, the conveying apparatus C includes: the chain-conveyor type conveying line L in which a plurality of support claw members 31, 31 for positioning the horizontally laid barrel B are continuously provided at equal intervals along a longitudinal direction; the lifting and rotating device 33 which is a lifting device that raises and lowers the barrel B relative to the conveying line L; and the position correction unit U (positioning means 51, movable body 48, cylinder 49, etc.) as position correction means that moves the lifting and rotating device 33 (movable body 48) so as to eliminate the deviation G when a central position A between the support claw members 31, 31 of the conveying line L is offset from a central position A′ of the lifting and rotating device 33 (lift portion 44). Therefore, according to the conveying apparatus C, since the barrel B can be guided on the conveying line to the filling and discharge apparatus 1 with the bunghole H oriented upward, liquid injection into the interior of the barrel B or liquid discharge therefrom can be performed reliably in a very short time.

Further, the conveying apparatus C includes the lifting and rotating device 33 that includes: the rotation mechanism (rotating bodies 53, 53, and the like) to rotate the lifted barrel B around its central axis; a detection unit (centering means 34, bung detection member 35, and the like) to detect the position of the bung T of the lifted barrel B; the bung removal means 37 to pull out the bung T detected by the detection unit; and the holding means 38 to hold the barrel B so as to restrict the barrel B from lifting during pulling out of the bung T by the bung removal means 37. Therefore, according to the conveying apparatus C, movement of the barrel B moves on the conveying line L during bung removal is restricted, and the barrel B can be guided to the filling and discharge apparatus 1 with the bunghole H oriented exactly vertically upward. Accordingly, liquid can be injected into the interior of the barrel B or discharged from the barrel B more reliably in an extremely short time.

### Modifications of Filling and Discharge Apparatus and Conveying Apparatus

The filling and discharge apparatus according to the present invention is not limited in any way to the aspects of the above embodiment, and various modification may be made without departing from the spirit of the present invention. For example, the configuration, such as shape, structure, size, and material, of a base, a support body, an arm, a hand body, a bearing, a drive device, a housing, an installation base, a mounting plate, a nozzle (the filling/discharge pipe), a camera, a proximity sensor, a suction port, and the like may be changed as appropriate. For example, the filling and discharge apparatus is not limited to a configuration in which, as in the above embodiment, a sensor for detecting the position of the bunghole includes a camera (image-processing camera) and a proximity sensor, and may instead employ a configuration in which the camera and the proximity sensor are integrated, or the like.

On the other hand, the conveying apparatus according to the present invention is not limited to a configuration in which the preparation operation for bung removal, the bung removal operation, and the discharging and the filling operations of the contents are performed at separate positions (stations), and it is also possible to change to a configuration in which any of the preparation operation for bung removal, the bung removal operation, and the discharging and the filling operations of the contents is performed at the same position, or to a configuration in which all of the preparation operation for bung removal, the bung removal operation, and the discharging and the filling operations of the contents are performed at the same position.

### INDUSTRIAL APPLICABILITY

The filling and discharge apparatus according to the present invention achieves the advantageous effects described above and can therefore be suitably used as an apparatus for automatically injecting liquid into a barrel and discharging liquid from a barrel on the conveying line. In addition, the conveying apparatus according to the present invention can be suitably used as a barrel conveying apparatus capable of automatically injecting liquid into and discharging liquid from barrels on the conveying line.

### DESCRIPTION OF REFERENCE SIGNS

1: filling and discharge apparatus
11: first drive device
12: second drive device
13: third drive device
14: fourth drive device
20: filling/discharge pipe (nozzle)
22: proximity sensor
24: base drive device
27: camera (sensor)
31: support claw member
33: lifting and rotating device (lifting device)
34: centering means (detection means)
35: bung detection member
36: drill
44: lift portion
48: movable body
49: cylinder
51: positioning means
52: positioning projection
53: rotating body (rotation mechanism)
61: control device
63: liquid filling/discharge pump
L: conveying line
C: conveying apparatus
M: bung removing device
M₁: bung removal preparation device
M₂: bung removing device
R: robot arm
U: position correction unit (position correction means)
B: barrel
T: bung
H: bunghole

1. A liquid filling and discharge apparatus for a barrel, used for filling a liquid into an interior of the barrel or discharging a liquid from the interior of the barrel, the liquid filling and discharge apparatus comprising:
a sensor configured to detect a position of an injection and discharge opening provided on a side surface of the barrel;
a long tubular nozzle configured to be inserted into the injection and discharge opening to inject and discharge the liquid; and
a drive mechanism configured to move the nozzle up and down.

2. The liquid filling and discharge apparatus for a barrel according to claim 1, wherein
the drive mechanism is capable of moving up and down along a vertical axis direction while maintaining a state in which the nozzle is oriented in a vertical direction.

3. A barrel conveyor system comprising:
the liquid filling and discharge apparatus for a barrel according to claim 1;
a chain-conveyor type conveying line that includes a plurality of support claw members to position a horizontally laid barrel, the plurality of support claw members being provided continuously at equal intervals along a longitudinal direction;
a lifting device configured to raise and lower the barrel relative to the conveying line; and
position correction means configured to move the lifting device so as to eliminate a misalignment thereof when a central position between the support claw members of the conveying line and a central position of the lifting device are misaligned.

4. A conveying apparatus for a barrel according to claim 3, wherein
the lifting device includes:
a rotation mechanism configured to rotate a lifted barrel around a central axis thereof;
detection means configured to detect a position of a bung of the lifted barrel;
bung removal means configured to pull out of the bung detected by the detection means; and
holding means configured to hold the barrel so as to restrict the barrel from lifting during pull out of the bung by the bung removal means.
